(19) United States
(12) Patent Application Publication
(10) Pub. No.: US 2023/0170545 A1
(43) Pub. Date: Jun. 1, 2023

(54) Cooling System for Single and Multi-Bay EV Structural Batteries

(71) Applicant: Volvo Car Corporation, Goteborg (SE)

(72) Inventors: Daniel Karlsson, Göteborg (SE); Martin Hjläm Wallborg, Harestad (SE); Klas Persson, Kungälv (SE)

(21) Appl. No.: 17/993,006

(22) Filed: Nov. 23, 2022

(30) Foreign Application Priority Data
Nov. 26, 2021 (EP) 21210640.5

(51) Int. Cl. H01M 10/625; H01M 10/6555; H01M 10/6567

(52) U.S. Cl. CPC H01M 10/625; H01M 10/6555; H01M 10/6567; H01M 2220/20

(57) ABSTRACT

In a battery pack for use in an electric vehicle at least two longitudinal rows of prismatic battery cells extend side-by side in the length direction (L). The cells are packed in an array including transverse rows. The array has longitudinal sides. Plate-shaped cooling members are interposed between adjacent cells in the longitudinal rows and extend in the width direction (W) from an upstream longitudinal side to the opposite longitudinal side of the array. Each plate-shaped cooling member is connected with an inlet to a coolant distribution duct and with an outlet to a coolant outflow duct. The distribution duct and the outflow duct extend parallel to sill members. The distribution duct is connected to a supply duct and the outflow duct is connected to a return duct, the supply duct and the return duct extending through the front piece and/or the transverse member.

### CROSS-REFERENCE TO RELATED APPLICATION

The present disclosure claims the benefit of priority of co-pending European Patent Application No. 21210640.5, filed on Nov. 26, 2021, and entitled “Cooling System for Single and Multi-Bay EV Structural Batteries,” the contents of which are incorporated in full by reference herein.

### TECHNICAL FIELD

The present disclosure relates to a battery pack for use in an electric vehicle. The battery pack includes a transverse front piece and a transverse member that each extend in a width direction and that are interconnected by two spaced-apart sill members extending in a length direction. At least two longitudinal rows of prismatic battery cells extend side-by side in the length direction.

The present disclosure also relates to a cooling member for use in such a battery back and to a method of manufacturing.

### BACKGROUND

Battery Electric Vehicles (BEV) and their power trains are commonly powered by an array of electrical cells, connected either in series, in parallel or in a combination of both in order to reach a desired system output voltage window that is optimal for motor and drive train efficiency. Battery cells come in different formats such as cylindrical or prismatic or pouch-shaped and generate heat due to internal resistance when power is drawn (acceleration) and applied (charging). Heat generated is actively removed to prevent cell temperature from exceeding a set threshold value at which breakdown of the cell electrolyte occurs, causing permanent damage and effectively lowering the cell lifespan.

It follows that one important design parameter for electric vehicle battery packs is to keep absolute temperature below a certain limit to ensure sufficient cell lifespan and product safety. However, depending on the cell internals and manufacturing methods used—wound or stacked jellyroll—heat is not distributed equally in all cell directions, effectively creating a temperature gradient with hotter and colder areas. It is desirable to reduce the temperature gradient as much as possible and reach a very even temperature distribution throughout the cell where the difference between hot and cold spots is reduced.

In order to protect the cell electrolyte in a battery cell from breaking down, power input and power output are limited (throttled back) when cell temperature exceeds a set value, usually coinciding with a cell hot spot forming. Hence, if one area of the cell is overheating, control hardware and software will initiate a throttling down protocol in order to protect the electrolyte. In practice, this issue is most frequently experienced by customers when fast-charging at high power and current. A regular fast-charging stop has a duration of 10-30 min, depending on the specific vehicle and the power rating of the charging station. The long charging times during power input contrast with power output from the cells during on-ramp acceleration or an overtaking situation, that are relatively short duration events, often less than a minute, but sometimes repeated a few times within a shorter time interval.

To deliver an improved fast-charging experience (lower charging time), battery packs will have to feature cells with optimized internals to avoid hot spot development and powerful cooling systems.

A battery pack is known having cylindrical battery cells, that are cooled by meandering cooling plates, extending in the length direction and connected in series. The known cooling plates result in uneven cooling along the length of the plates and may lead to local hot spots.

It is an objective of the present disclosure to provide a battery pack with an effective cooling system having a substantially homogenous temperature distribution when power is supplied by the battery cells and when the cells are being charged. It is another objective to provide an electric vehicle having a structural battery that is of relatively low weight and that can be charged in a relatively fast charging cycle.

### SUMMARY

A battery pack is provided for use in an electric vehicle. The battery pack includes a transverse front piece and a transverse member that each extend in a width direction and that are interconnected by two spaced-apart sill members extending in a length direction. At least two longitudinal rows of prismatic battery cells extend side-by side in the length direction. The cells are packed in an array including transverse rows. The array has longitudinal sides. The battery pack further includes plate-shaped cooling members being interposed between adjacent cells in the longitudinal rows and extending in the width direction from a first longitudinal side to a second longitudinal side of the array. Each plate-shaped cooling member is connected with an inlet to a coolant distribution duct and with an outlet to a coolant outflow duct. The distribution duct and the outflow duct extend parallel to the sill members. The distribution duct is connected to a coolant supply duct and the outflow duct is connected to a return duct. The coolant supply duct and the return duct extend through the front piece and/or through the transverse member. In this configuration, the at least two longitudinal rows extend in the length direction. Moreover, the at least two longitudinal rows are arranged side-by-side. This means that the at least two longitudinal rows are arranged adjacent to each other in the width direction. Within one row, the prismatic battery cells forming the row are arranged adjacent to one another in the length direction. Cells of neighboring longitudinal rows being arranged adjacent to one another form transverse rows.

The plate-shaped cooling members extend along the transverse rows of prismatic battery cells.

The directions such as the width direction or the traverse direction and the length direction or the longitudinal direction refer to directions of the battery pack. This means that the width direction or the transverse direction are to be understood as a width direction of the battery pack or a transverse direction of the battery pack. In the same manner, the length direction or the longitudinal direction are to be understood as a length direction of the battery pack or a longitudinal direction of the battery pack.

In a case in which the battery pack is mounted in a vehicle, the directions of the battery pack may correspond to the directions of the vehicle. This means that the width direction of the battery pack or the transverse direction of the battery pack correspond to a width direction of the vehicle or a transverse direction of the vehicle and the length direction of the battery pack or the longitudinal direction of the battery pack correspond to a length direction of the vehicle or a longitudinal direction of the vehicle.

The parallel supply of the coolant to the plate-shaped cooling members according to the present development results in effective cooling, allowing the maximum temperature of the battery pack to be lowered. In this way, the maximum temperature can be monitored and kept below a temperature threshold value and degradation of the electrolyte of the battery cells can be reduced. The parallel coolant distribution also results in improved uniformity of cooling, avoiding local hot spots and allowing faster charging rates at relatively high power input (ampere) for a longer period of time before the need for throttling back due to local hot spots in one or more cells.

The low temperature differences on cell level increase the cell lifespan. The cells in the battery pack according to the present development experience less degradation (slower ageing) by the internal temperatures being kept at a more uniform level, allowing the electrochemical reactions to progress and run in an equally uniform fashion. A cooling member may be provided between each pair of adjacent transverse rows of cells. This means that a cooling member is arranged between any two transverse rows of cells. Consequently, cells and cooling members are arranged in an alternating manner when following the length direction. Thus, each cell in the battery pack is cooled along at least one side surface for optimal cooling and avoiding local hot spots.

In an alterative, a cooling member is provided between each second pair of adjacent transverse rows of cells. This means that at every second interface between adjacent transverse rows of cells, a cooling member is provided. At every other interface between adjacent transverse rows of cells there is no coolant member. This applies when following the length direction. In other words, again following the length direction, the following pattern is created: Transverse cell row-transverse cell row-cooling member-transverse cell row-transverse cell row-cooling member etc. This alternative provides a good compromise between structural simplicity and effective cooling.

It is noted that the alternative wherein a cooling member is provided between each pair of adjacent transverse rows of cells and the alternative wherein a cooling member is provided between each second pair of adjacent transverse rows of cells may be combined. This means that in a first section of the battery pack, a cooling member is provided between each pair of adjacent transverse rows of cells. In a second section of the battery pack, a cooling member is provided between each second pair of adjacent transverse rows of cells. Thus, coolant members can be arranged within the cell pack as needed in a specific application.

The front piece and the transverse member may exert a compressive force of between 20 and 200 kN/m2 on the cells in the length direction. In other words, the cells and the plate-shaped cooling members are compressed between the front piece and the transverse member.

The pre-compressed stack of cells and cooling plates between the front piece and the transverse member results in a light-weight structural battery that can be effectively and uniformly cooled.

The inlet duct may be connected to the distribution duct at or near a midpoint of the distribution duct. The midpoint of the distribution duct may correspond to a midpoint of the cell array along the length direction.

This results in a symmetric flow distribution along the cooling members and increases the uniformity of the cooling when seen in the length direction.

In a battery pack according to the disclosure, a cooling member may be provided between the transverse front piece and an adjacent transverse row of cells and between the transverse member and an adjacent transverse row of cells.

By cooling both long faces of the first and last transverse rows of cells, each cell abutting a transverse beam, overheating of said cells is prevented.

In a battery pack, a distance between the longitudinal sides of the array and the sill members in the width direction may be 5 cm to 25 cm. The coolant inlet duct and the coolant return duct extend between the longitudinal sides of the array and the sill members.

The coolant supply ducts and the coolant return duct are integrated in a compact construction by being accommodated in the space between the sill members and the array of battery cells. This results in a battery pack of reduced height and creates a strong bond between the cooling channels and the cells, reinforcing the construction of a structural battery pack.

The transverse member of the battery pack may include a beam or a foot garage, and a rear transverse piece interconnecting the rear parts of the sill members. A first array of the cells is situated between the front transverse member and the beam or foot garage. A second array of cells is situated between the beam or foot garage and the rear transverse piece. Each array of cells is provided with respective cooling members, coolant inlet and distribution ducts and outflow and return ducts. The inlet and return ducts of the first array and the second array of cells extend through the front transverse piece and the beam or foot garage. The first array may be considered as a sub-array of the array of cells as defined above. Also the second array may be considered as a sub-array of the array of cells as defined above.

In the present context, a foot garage is to be understood as a part or assembly that includes a receptacle or receiving space which is accessible for at least one human foot. This applies in a situation in which the battery pack is mounted in the vehicle.

The cells are accommodated in a front cell bay and a rear cell bay, each with their own cooling system. A transverse beam in the form of a foot garage will offer improved ergonomics in low vehicles. A transverse beam acting as a scaling member in the length direction (e.g. in the middle) of the pack reinforces the construction of a structural battery pack.

A battery pack may be provided in which each cooling member includes two parallel plates with an end cap having two lateral tube sections. The lateral tube sections may be interconnected to form the distribution duct.

The cooling members have a slim and compact design and provide a large heat exchanging surface with the side faces of the battery cells. The plate shaped cooling members can easily be manufactured by extrusion. The walls and cross-section of the cooling members will be balanced in thickness and surface area between the need for optimal cooling and the compressive force that needs to be exerted on the cells in the length direction when the cells age and swell. If the cooling members are too thin, they could collapse under pressure, leading to uncontrolled swelling and drastically reduced cell lifespan.

The lateral tubes sections of adjacent cooling members may be interconnected via a flexible tube member respectively.

The lateral tubes on the cooling members form spigots, preferably made of aluminum. The facing spigots of adjacent cooling members are interconnected by a piece of flexible hose or tubing that is snapped into place to complete the connection and forming a continuous distribution channel for the cooling fluid.

A support structure may be arranged between the two parallel plates of at least one of the cooling members. The support structure may be resilient. In this case, the support structure may be designated as a spring element or spring structure. This has the effect that even in a case in which the front piece and the transverse member exert a compressive force along the length direction on the cells and the cooling members arranged there between, a flow channel of sufficient size is maintained between the two parallel plates. Moreover, such a support structure has the effect that the compressive force is evenly distributed over the cells and the cooling members.

The support structure may be made from a metal material or a plastics material.

The support structure may include an undulated profile. Preferably, the support structure has an undulated profile when being regarded along the width direction. This has the advantage that sufficiently sized flow channels for coolant are provided in the width direction. At the same time, such cooling members are highly stable.

Such an undulated profile may be generated by deforming a sheet material, e.g. a sheet metal or a plastics sheet. Alternatively, such an undulated profile may be produced using an extrusion process.

In an example, a support structure may be arranged between the two parallel plates of every cooling member.

A distribution cooling member may be provided in the battery pack with an end part having an attachment part extending substantially parallel to the plate members and a cover that is in liquid-tight engagement with the attachment part for forming a receiving chamber, and a connector stub for connecting to the inlet duct. Thus, coolant may be provided to the cooling members in a reliable manner.

A cooling member according to the disclosure may include two parallel plate members and two end caps being arranged substantially parallel to the plate members. The end caps may be in liquid-tight connection with the plate members and may be joined in a liquid-tight manner along a perimeter. The cooling member may further include a tube section extending on each side of the end caps, transversely to a plane of the plate members, and being adapted to be connected to a neighboring tube section for forming a distribution duct with neighboring cooling members. Such a cooling member may be designated as a cooling member of a first type.

An end cap may include an attachment part extending substantially parallel to the plate members and a cover that is in liquid-tight engagement with the attachment part for forming a receiving chamber, and a connector stub for connecting to the inlet duct.

Another cooling member according to the present disclosure may include two parallel plate members and two end caps being in liquid-tight connection with the plate members, wherein at least one end cap has an attachment part extending substantially parallel to the plate members, and a cover that is in liquid-tight engagement with the attachment part for forming a receiving chamber. The cooling member further includes a connector stub for connecting to the inlet duct. Such a cooling member may be designated as a cooling member of a second type.

The cooling members according to the present disclosure may be cooling members for a battery pack according to the present disclosure.

A cooling system for a battery pack includes at least one cooling member of the first type and/or at least one cooling member of the second type. Using such a cooling system allows to effectively and efficiently control a temperature within the battery pack.

In an example, the cooling system includes a plurality of cooling members of the first type, each cooling member being interposed between adjacent cells. Additionally, the cooling system may include one cooling member of the second type for supplying coolant to the cooling members of the first type.

An electric vehicle includes a battery pack of the present disclosure. Since in such a battery pack effective and efficient cooling may be guaranteed, relatively fast charging is possible.

A method of manufacturing a battery pack for an electric vehicle, includes:

forming an array of at least two rows of prismatic battery cells extending side-by side in the length direction and plate-shaped cooling members, that are placed between adjacent cells and extending in the width direction from an upstream longitudinal side to the opposite longitudinal side of the array, the cells being arranged in transverse rows, and the array having longitudinal sides,

clamping the array between a transverse front piece and a transverse member extending in a width direction in order to compress the array,

interconnecting the transverse front piece and the transverse member via two sill members extending along each longitudinal side, and

connecting the cooling members to a coolant supply duct and a coolant return duct, that extend through the transverse front piece and/or through the transverse member.

Prior to the connection of the sill members, the cooling plates may be interconnected via flexible duct segments.

In an example, the method of manufacturing a battery pack relates to a method of manufacturing a battery pack according to the present disclosure.

### BRIEF DESCRIPTION OF THE DRAWINGS

Embodiments of a battery pack including cooling members according to the disclosure will, by way of non-limiting examples, be described in detail with reference to the accompanying drawings. In the drawings:

FIG. 1 shows an electric vehicle including a battery pack,

FIG. 2 shows a perspective view of a battery pack including a cooling system,

FIG. 3 shows a top view of the battery pack of FIG. 2,

FIG. 4 shows a detailed view of the inlet duct of the cooling system of FIG. 2,

FIG. 5 shows a detailed view of a distribution duct of the cooling system of FIG. 2,

FIG. 6 shows a distribution member of the cooling system of FIG. 2,

FIG. 7 shows the connection of the inlet duct to the distribution member,

FIG. 8 shows the distribution member on an enlarged scale,

FIG. 9 shows a partial cross-section of the cooling system of FIG. 2, and

FIG. 10 shows a detail of a cooling member of the battery pack of FIG. 2.

### DETAILED DESCRIPTION

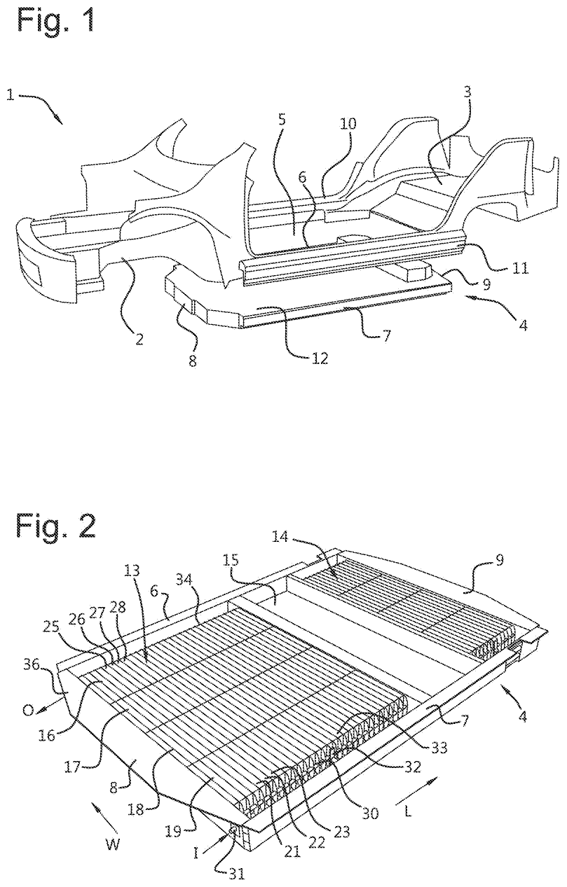

FIG. 1 shows a frame 1 of an electric vehicle, including a front frame structure 2, a rear frame structure 3, including a rear floor, and a structural battery pack 4, forming a bottom structure 5 of the vehicle. The structural battery pack 4 includes longitudinal sill profiles 6, 7 and transverse front and rear beams 8, 9. The sill profiles 6, 7 are connected to sill members 10, 11 of the frame and the transverse beams 8, 9 are connected to the front and rear frame structures 2, 3. A top plate 12 of the battery pack 4 forms the bottom of the cabin of the vehicle.

FIG. 2 shows two arrays 13, 14 of prismatic battery cells that are arranged in rows 16, 17, 18, 19 extending in the length direction L. The battery cells in the front array 13 are compressed between the front beam 8 and a foot garage 15. The battery cells in the rear array 14 are compressed between the foot garage 15 and the rear beam 9.

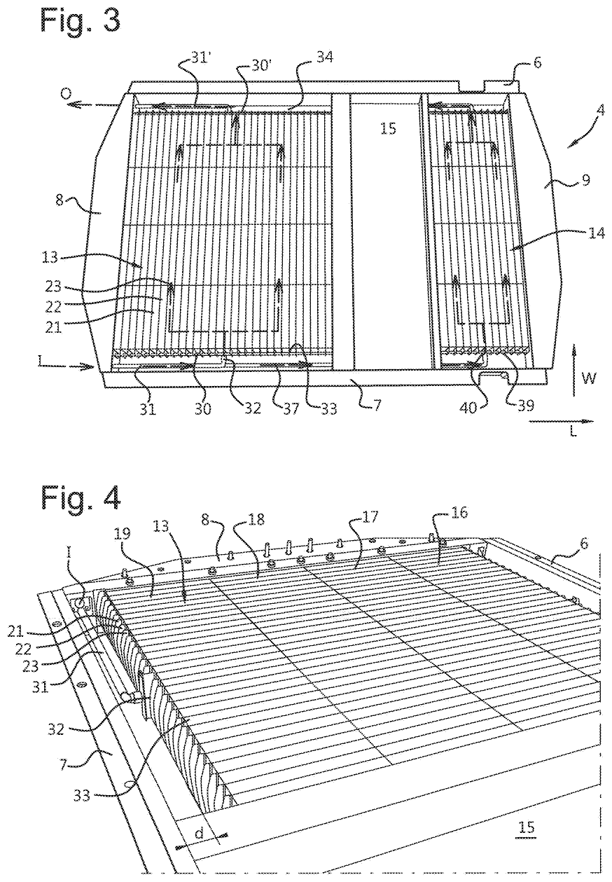

Cooling plates 21, 22, 23 extend in the width direction W along the transverse rows 25, 26, 27, 28 of the battery cells for cooling of the side surfaces of the cells. The cooling plates 21, 22, 23 are connected with their end parts to a fluid distribution duct 30 that receives cooling liquid via inlet duct 31, indicated at arrow I. In a similar manner, the outlets of the cooling plates 21, 22, 23 are connected to coolant outflow duct 30′ and to a return duct 31′, as shown in FIG. 3. The inlet duct 31, the fluid distribution duct 30 and the distribution member 32 are placed between the longitudinal sill member 7 and a longitudinal side 33 of the array of cells 13. At the opposite side, the fluid outflow duct 30′ and the return duct 31′ are situated between the sill profile 6 and longitudinal side 34 of the array 13. Heated coolant flows from the return duct 31′ to an outlet 36, indicated at arrow O.

FIG. 3 shows the inlet duct 31 being connected to the cooling plates 21, 22, 23 of the front array 13 of battery cells and continuing via inlet duct 37 that extends through the foot garage 15 to the distribution member 40 of a rear distribution duct 39. The rear distribution duct 39 supplies coolant to the cooling members of the rear array 14 of cells. As indicated by the arrows, cold coolant enters via inlet I into the cooling plates 21, 22, 23 at an upstream longitudinal side 33 of the arrays 13, 14 of battery cells and flows in the width direction W to the downstream longitudinal side 34. There the heated coolant is transported via outflow duct 30′ and return duct 31′ to coolant outlet O.

It is noted that in the example of FIG. 3, the inlet duct 31 extends through the transverse front piece or transverse front beam 8. Also the return duct 31′ extends through the transverse front piece or transverse front beam 8. In an alternative, the inlet duct 31 may extend through the transverse rear beam 9. Additionally, the return duct 31′ may extend through the transverse rear beam 9. These two examples may also be combined such that the inlet duct 31 extends through both the transverse front beam 8 and the transverse rear beam 9. In this combination, also the return duct 31′ extends through both the transverse front beam 8 and the transverse rear beam 9.

FIG. 4 shows the inlet duct 31 extending from the inlet I in the space between the sill profile 7 and the longitudinal side 33 of the array 13 of cells, to the distribution member 32. A distance d between the sill profile 7 and the longitudinal side 33 may be 5 cm to 25 cm.

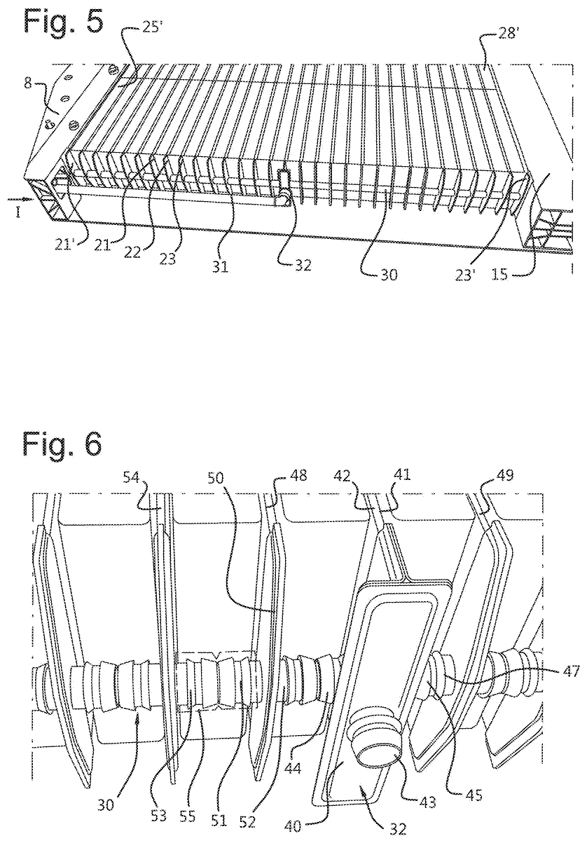

FIG. 5 shows the inlet duct 31 and the distribution duct 30 that interconnects the cooling members 21, 22, 23.

FIG. 6 shows a perspective view on an enlarged scale of the central distribution member 32, having a T-shaped end part 40. The end part 40 seals the end face of the cooling channel that is formed between the parallel cooling plates 41, 42. The end part 40 includes a connector stub 43 for connecting to the inlet duct 31 and two side spigots 44, 45 for connecting to spigots 47, 52 of adjacent cooling members 48, 49 for forming the distribution duct 30.

For each cooling member 48, 49, 54 a cooling channel is enclosed between the parallel cooling plates of the cooling member. The cooling members are each at their end faces provided with an end cap 50 that seals the end face of the cooling channel and that is provided two side spigots 51, 52. The side spigots 51, 53 of adjacent cooling members 48, 54 are interconnected via a flexible tubular member 55, for instance a rubber hose, that is snapped in place upon completion the distribution duct 30.

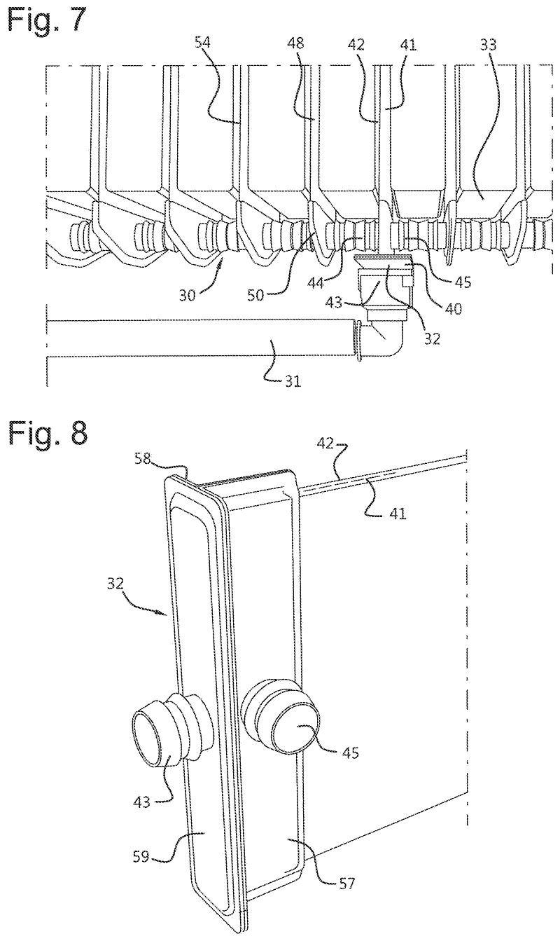

FIG. 7 shows a top view of the inlet duct 31 connected to the connector stub 43 of the end part 40 of distribution member 32.

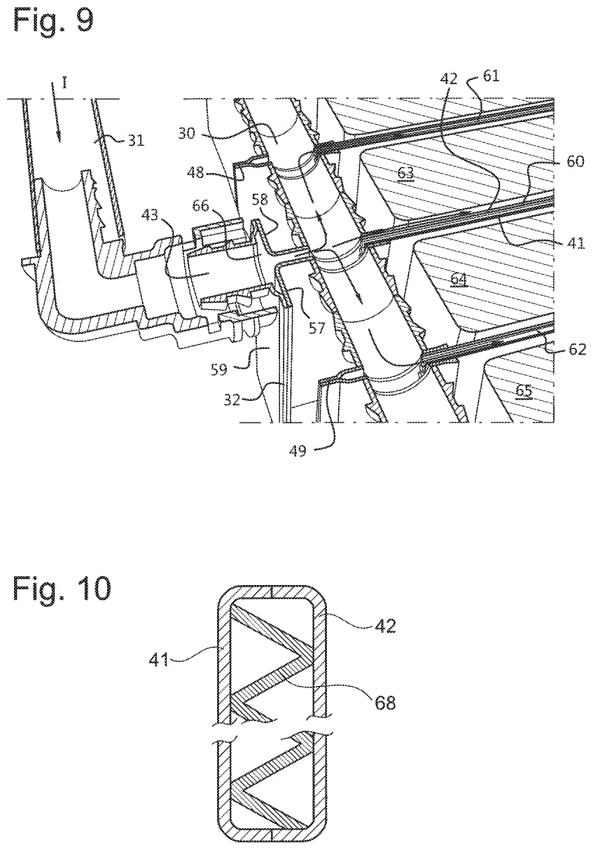

FIG. 8 shows the distribution member 32 being formed of two T-shaped end flanges 57, 58 that each include a side spigot 45, and a transverse end cap 59 carrying the connector stub 43. The end cap 59 and flanges 57, 58 define a receiving chamber 66 for the coolant entering through the inlet duct, that is shown in FIG. 9. From the receiving chamber 66, the coolant is passed into the distribution duct 30 via the side spigots 45, and into the cooling channel that is defined between the cooling plates 41, 42. The cooling plates 41, 42, the T-shaped flanges and the end cap 59 may be formed of aluminum and can be interconnected by brazing, clinching or hemming.

FIG. 9 shows parallel cooling channels 60, 61, 62 situated between adjacent transverse rows of cells 63, 64, 65. The coolant that is supplied by the inlet duct 31 is distributed from the receiving chamber 66 of the distribution member 32 in two opposite length directions into the distribution duct 30. The distribution member 32 is placed at the midpoint of the distribution duct, so that a uniform flow of coolant passes through all cooling members. From the distribution duct 30, the coolant enters into the cooling channels that are in heat exchanging contact with the side faces of the battery cells 63, 64, 65. The coolant passes to a downstream side of the transverse rows of cells 63, 64, 65 to be transported to an outlet via an outlet configuration that is similar in lay-out to the inlet configuration that is shown in FIG. 9.

FIG. 10 shows a detail of the cooling members 21, 22, 23.

The cooling members 21, 22, 23 include a support structure 68 being arranged between the two parallel plates 41, 42.

In the example shown in FIG. 10, the support structure 68 is made from metal and is formed as an undulated or zig-zagged profile. The undulated or zig-zagged structure may be seen when regarding the support structure 68 in the width direction.

The portions of the interior of cooling member 21, 22, 23 which are not occupied by the support structure 68 serve as flow channels for coolant. In other words, the support structure 68 does only slightly or not at all inhibit a flow of coolant in the width direction.

The support structure 68 provides a spring functionality, if the cells and the cooling members 21, 22, 23 are compressed in the length direction. Consequently, the compression force is evenly distributed and does not lead to a severe reduction of an available cross section of the flow channels.

1. A battery pack for use in an electric vehicle, the battery pack comprising:
a transverse front piece and a transverse member that each extend in a width direction (W) and that are interconnected by two spaced-apart sill members extending in a length direction (L),
at least two longitudinal rows of prismatic battery cells extending side-by-side in the length direction (L), the cells being packed in an array comprising transverse rows, the array having longitudinal sides, and
plate-shaped cooling members being interposed between adjacent cells in the longitudinal rows and extending in the width direction (W) from a first longitudinal side to a second longitudinal side of the array, each plate-shaped cooling member being connected with an inlet to a coolant distribution duct and with an outlet to a coolant outflow duct,
the distribution duct and the outflow duct extending parallel to the sill members, the distribution duct being connected to a coolant supply duct and the outflow duct being connected to a return duct, the coolant supply duct and the return duct extending through the front piece and/or through the transverse member.

2. The battery pack according to claim 1, wherein a cooling member is provided between each pair of adjacent transverse rows of cells.

3. The battery pack according to claim 1, wherein a cooling member is provided between each second pair of adjacent transverse rows of cells.

4. The battery pack according to claim 1, wherein the front piece and the transverse member exert a compressive force of 20 to 200 kN/m2 on the cells in the length direction.

5. The battery pack according to claim 1, wherein the inlet duct is connected to the distribution duct at or near a midpoint of the distribution duct.

6. The battery pack according to claim 1, wherein a cooling member is provided between the transverse front piece and an adjacent transverse row of cells and between the transverse member and an adjacent transverse row of cells.

7. The battery pack according to claim 1, wherein a distance (d) between the longitudinal sides of the array and the sill members in the width direction (W) is 5 cm to 25 cm, the coolant inlet duct and the coolant return duct extending between the longitudinal sides of the array and the sill members.

8. The battery pack according to claim 1, wherein the transverse member comprises a beam or a foot garage, and a rear transverse piece interconnecting the rear parts of the sill members,
wherein a first array of cells is situated between the front transverse member and the beam or foot garage, a second array of cells is situated between the beam or foot garage and the rear transverse piece, each array of cells being provided with respective cooling members, coolant inlet and distribution ducts and outflow and return ducts, the inlet and return ducts of the first array and the second array of cells extending through the front transverse piece and the beam or foot garage.

9. The battery pack according to claim 1, wherein each cooling member comprises two parallel plates with an end cap, having two lateral tube sections, the tube sections being interconnected to form the distribution duct.

10. The battery pack according to claim 9, wherein the lateral tube sections of adjacent cooling members are interconnected via a flexible tube member respectively.

11. The battery pack according to claim 9, wherein a support structure is arranged between the two parallel plates of at least one of the cooling members.

12. The battery pack according to claim 1, wherein a distribution cooling member is provided with an end part having an attachment part extending substantially parallel to the plate members and a cover that is in liquid-tight engagement with the attachment part for forming a receiving chamber, and a connector stub for connecting to the inlet duct.

13. A cooling member for a battery pack, the cooling member comprising:
two parallel plate members,
two end caps being arranged substantially parallel to the plate members, being in liquid-tight connection with the plate members and being joined in a liquid-tight manner along a perimeter, and
a tube section extending on each side of the end caps, transversely to a plane of the plate members and being adapted to be connected to a neighboring tube section for forming a distribution duct with neighboring cooling members.

14. A cooling member for a battery pack, the cooling member comprising:
two parallel plate members,
two end caps, being in liquid-tight connection with the plate members, wherein at least one end cap has an attachment part extending substantially parallel to the plate members, and a cover that is in liquid-tight engagement with the attachment part for forming a receiving chamber, and
a connector stub for connecting to the inlet duct.

15. A cooling system for a battery pack comprising at least one cooling member of claim 13.

16. A cooling system for a battery pack comprising at least one cooling member of claim 14.

17. An electric vehicle comprising the battery pack of claim 1.

18. A method of manufacturing a battery pack for an electric vehicle, the method comprising:
forming an array of at least two rows of prismatic battery cells extending side-by side in the length direction (L) and plate-shaped cooling members, that are placed between adjacent cells and extend in the width direction (W), from an upstream longitudinal side to the opposite longitudinal side of the array, the cells being arranged in transverse rows, and the array having longitudinal sides,
clamping the array between a transverse front piece and a transverse member extending in a width direction (W) in order to compress the array,
interconnecting the transverse front piece and the transverse member via two sill members extending along each longitudinal side, and
connecting the cooling members to a coolant supply duct and a coolant return duct, that extend through the transverse front piece and/or through the transverse member.

19. The method according to claim 18, wherein prior to the connection of the sill members, the cooling members are interconnected via flexible tube segments.
